(19) United States
(12) Patent Application Publication
(10) Pub. No.: US 2010/0314908 A1
(43) Pub. Date: Dec. 16, 2010

(54) CAB FRAME BELTLINE MEMBER

(76) Inventors: Robert Lee Wood, JR., Independence, KS (US); Trace Dustin Landers, Denver, IA (US); Wayne Douglas Mugge, Dike, IA (US); Charles Nicholas Warren, Cedar Falls, IA (US)

Correspondence Address: DEERE & COMPANY, ONE JOHN DEERE PLACE, MOLINE, IL, 61265, US

(21) Appl. No.: 12/481,868

(22) Filed: Jun. 10, 2009

(51) Int. Cl. B62D 33/06; B62D 25/00; E02F 9/16

(52) U.S. Cl. 296/190.03; 296/190.08

(57) ABSTRACT

A ROPS-capable cab frame beltline support member for a vehicle cab frame which includes left and right rear corner posts. The beltline support member extends between the rear corner posts and is spaced apart above the lower ends of the posts. The support member includes first and second parts welded together. The support member includes a central portion, a left end fixed to the left rear corner post and a right end fixed to the right rear corner post. The central portion is offset rearwardly with respect to its left and right ends. The first part includes a midportion, a left flange portion and a right flange portion. The midportion has a C-shaped cross sectional shape. The midportion of the first part has a wider upper side, a back plate and a narrower lower side. The second part includes flanged ends and an elongated member having a first edge which engages an inner surface of the first part, and having a side surface which engages an edge of the first part. The flange portions are attached to slanted transition portions of the corner posts and form gussets between the rear corner posts and the beltline support member.

### FIELD OF THE INVENTION

The present invention relates to a cab frame structure for vehicles such as large agricultural tractors, and more specifically to a beltline member for a cab frame structure which is capable of providing roll-over protective (ROP).

### BACKGROUND OF THE INVENTION

A cab frame structure is shown in U.S. Pat. No. 6,543,840, issued in April 2003 to Collier et al. However, it appears that this cab frame structure does not include a ROPs sufficient beltline or beltline level support member between the rear corner posts, since the patent does not show any gusseting between a beltline level support member and the rear corner posts.

Large agricultural tractors have cab frames which are designed to perform as roll-over protective structures or ROPS. In such structures the beltline area requires a lot of support between the rear corner posts due to the significant loads being transferred from the upper portion of the cab frame to the cab mounting structure. The cab frame must meet force, energy, and zone of clearance constraints. The beltline support has proven to be crucial when meeting these specifications and has required additional bracing and gussets to achieve the desired stiffness and support. Some previous production designs have required as many as seven to eight beltline parts to meet design requirements. It is desired to have a simpler yet robust beltline support design.

### SUMMARY OF THE INVENTION

Accordingly, an object of this invention is to provide a simple yet robust beltline support for a ROPs cab frame.

A further object of the invention is to provide such a ROPs beltline support which creates more room in the cab interior.

These and other objects are achieved by the present invention, wherein a beltline support member is formed by two separate parts which are welded together. The support member includes a central portion, a left end fixed to the left rear corner post and a right end fixed to the right rear corner post. The central portion is curved or offset to the rear to allow for more room in the interior of the cab. The offset allows the seat to mover farther rearward, between the rear corner posts, thus creating a larger space for the operator.

The first part includes a midportion, a left flange portion and a right flange portion. The midportion has a C-shaped cross sectional shape. The midportion of the first part has a wider upper side, a back plate and a narrower lower side. The second part includes an elongated midportion and left and right flanges which are attached to the front side of the rear corner posts. The midportion has a first edge which engages an inner surface of the first part, and has a side surface which engages an edge of the first part.

### BRIEF DESCRIPTION OF THE DRAWINGS

FIG. 1 is a perspective view of a tractor cab frame embodying the present invention;

FIG. 2 is an enlarged partially exploded rear perspective view of a portion of FIG. 1;

FIG. 3 is an enlarged partially exploded front perspective view of a portion of FIG. 1;

FIG. 4 is a sectional view taken along lines 4-4 of FIG. 1; and

FIG. 5 is a top view of a rear portion of the cab frame of FIG. 1.

### DESCRIPTION OF THE PREFERRED EMBODIMENT

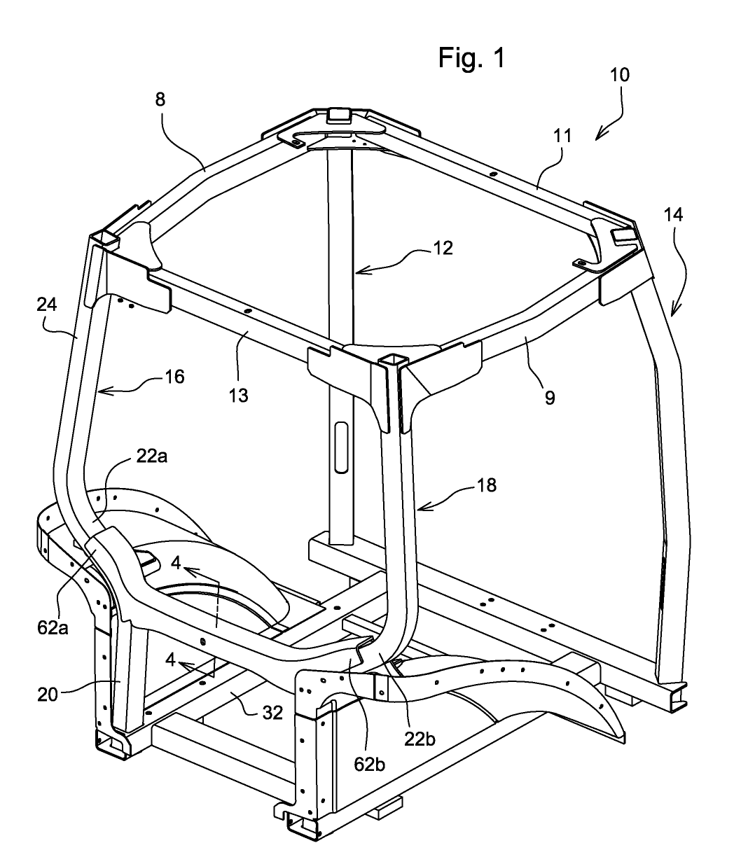

Referring to FIGS. 1-3, a ROPS-capable cab frame 10 for an agricultural vehicle, such as a tractor, includes left and right front corner posts 12 and 14, and left and right rear corner posts 16 and 18. The upper ends of these posts are joined together by upper side posts 8 and 9, upper front post 11 and upper rear post 13.

Each of the rear corner posts 16 and 18 are formed from a tube which is bent or curved to define lower portions 20a and 20b, slanted transition portions 22a and 22b and upper portions 24a and 24b. Lower portions 20a and 20b are positioned at the rear of the cab inwards of the rear wheel fenders 30a and 30b. The slanted transition portions 22a and 22b are between the lower portions 20a and 20b and the upper portions 24a and 24b.

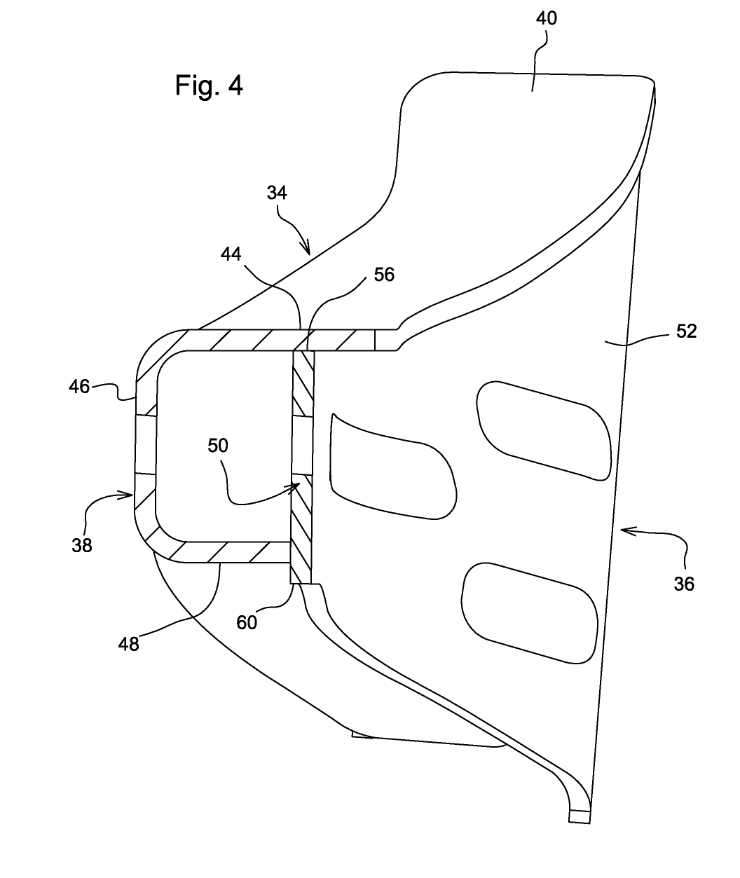

Transition portions 22a and 22b are joined together by a beltline or waist level member 32. Beltline member 32 includes a ROPS-capable rear beltline member 34 and a front beltline member 36 which are welded together, and which are welded to the respective transition portions. Rear beltline member 34 includes a central portion 38, a left flange 40 and a right flange 42. As best seen in FIG. 4, the central portion 38 has a C-shaped cross-sectional shape with an upper side 44, a back plate 46 and a lower side 48. The upper side 44 is wider than the lower side 48. As best seen in FIGS. 1-3, the flanges 40 and 42 form lips 62a and 62b which are conformed to and are welded to the top and rear sides of the respective transition portions 22a and 22b.

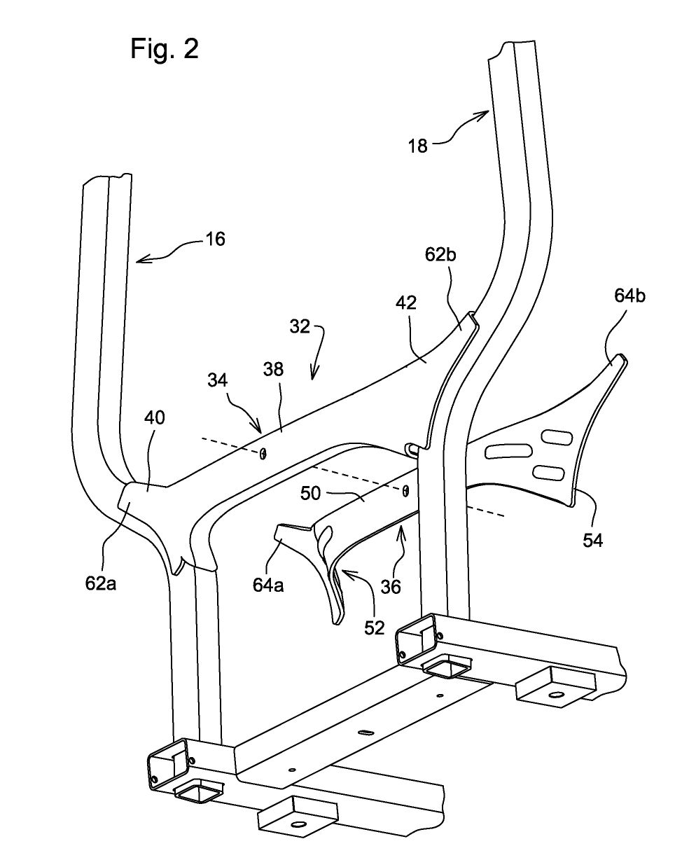

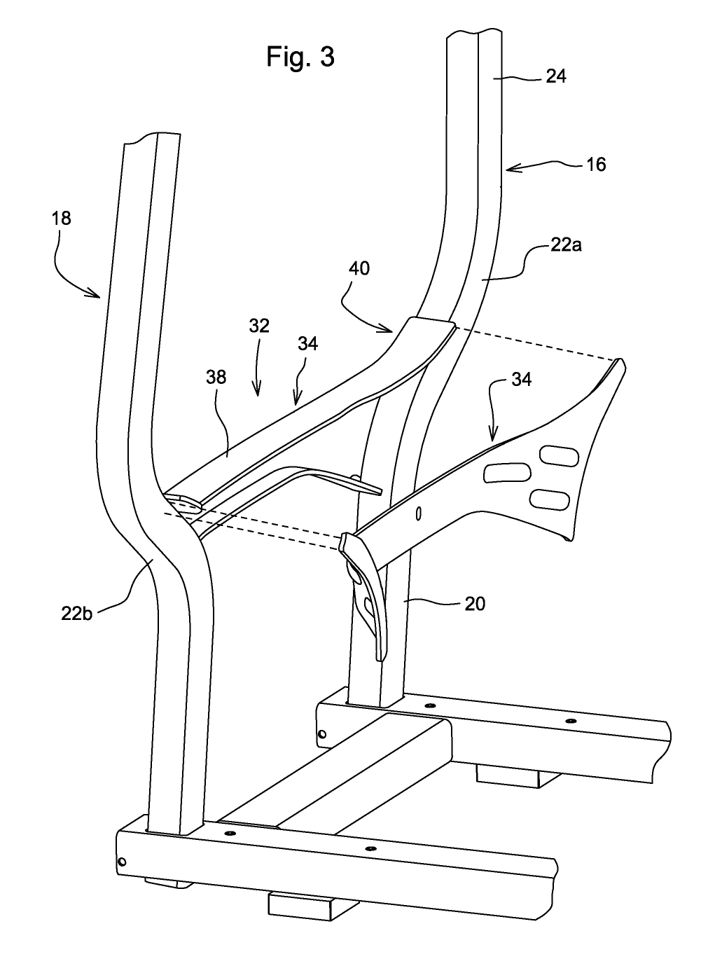

Front beltline member 36 includes a central portion 50, a left flange 52 and a right flange 54. As best seen in FIG. 4, the central portion 50 has a flat cross-sectional shape with an upper edge 56, a back side 58 and a lower edge 60. The upper edge 56 is welded to a bottom surface of the upper side 44 of the rear beltline member 34. The front edge of lower side 48 is welded to a lower portion of the front beltline member 36. As best seen in FIGS. 2 and 3, the flanges 52 and 54 form lips 64a and 64b which are conformed to and are welded to front sides of the respective transition portions 22a and 22b.

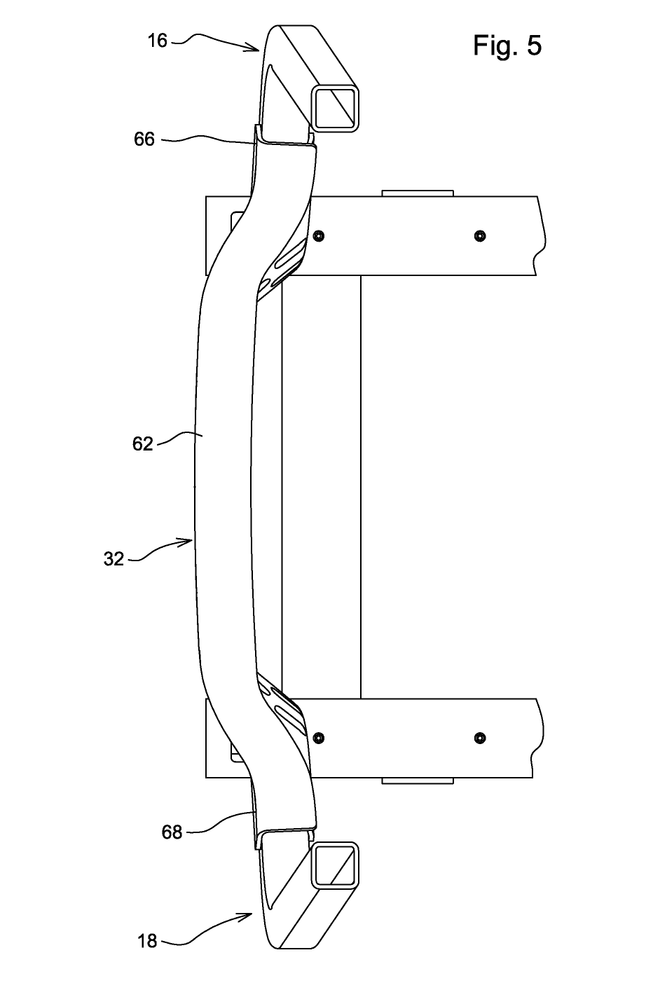

As best seen in FIG. 5, the central portion 62 of the beltline member 32 is offset to the rear with respect to its left and right end portions 66 and 68. This offset allows for more room in the interior of the cab.

The flanges 40, 42, 52 and 54 form gussets between the rear corner posts and the beltline member parts 32 and 36. The result is a two-piece, rear, ROPS-capable beltline support for an agricultural tractor cab. This support provides sufficient structural support to the beltline region of the cab frame that is needed for ROPS certification, while at the same time significantly reducing the overall part count to achieve this functionality. The beltline member also includes a rearward offset between the cab rear corner posts. This rearward offset increases the amount of room available to the operator inside of the cab.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A cab frame for a vehicle, the cab frame having a left rear corner post and a right rear corner post, the rear corner posts extending upwardly from lower ends which are attached to a frame of the vehicle, and the cab frame having a beltline support member extending between the rear corner posts and spaced apart above the lower ends of the posts, characterized by:
the support member comprising a first part and a second part attached to the first part, and the support member forming gusseting portions which are attached to the rear corner posts.

2. The cab frame of claim 1, wherein:
the support member comprises a central portion, a left end fixed to the left rear corner post and a right end fixed to the right rear corner post, the central portion being offset rearwardly with respect to its left and right ends.

3. The cab frame of claim 1, wherein:
the first part comprises a midportion, a left flange portion and a right flange portion, the midportion having a C-shaped cross sectional shape; and
the second part comprising an elongated member having a first edge which engages an inner surface of the first part, and having a side surface which engages an edge of the first part.

4. The cab frame of claim 1, wherein:
the first part comprises a midportion having an upper side, a back plate and a lower side, one of said sides being wider than the other of said sides; and
the second part comprising an elongated member having a first edge which engages a surface the wider one of the sides of the first part, and the elongated member having a side surface which engages an edge of the other side of the of the first part.

5. The cab frame of claim 1, wherein:
each of the rear corner posts is bent to form a transition portion between an upper portion and a lower portion; and
the support member is fixed to the transition portions of both rear corner posts.

6. A ROPS-capable cab frame for a vehicle, the cab frame comprising:
a left rear corner post and a right rear corner post, the rear corner posts extending upwardly from lower ends which are attached to a frame of the vehicle; and
a ROPS-capable beltline support member extending between the rear corner posts and spaced apart above the lower ends of the posts, the support member comprising a first part and a second part welded to the first part, and the support member forming gusseting portions which are attached to the rear corner posts.

7. The cab frame of claim 6, wherein:
the support member comprises a central portion, a left end fixed to the left rear corner post and a right end fixed to the right rear corner post, the central portion being offset rearwardly with respect to its left and right ends.

8. The cab frame of claim 6, wherein:
the first part comprises a midportion, a left flange portion and a right flange portion, the midportion having a C-shaped cross sectional shape; and
the second part comprising an elongated member having a first edge which engages an inner surface of the first part, and having a side surface which engages an edge of the first part.

9. The cab frame of claim 6, wherein:
the first part comprises a midportion having an upper side, a back plate and a lower side, one of said sides being wider than the other of said sides; and
the second part comprising an elongated member having a first edge which engages a surface the wider one of the sides of the first part, and the elongated member having a side surface which engages an edge of the other side of the of the first part.

10. The cab frame of claim 6, wherein:
each of the rear corner posts is bent to form a transition portion between an upper portion and a lower portion; and
the support member is fixed to the transition portions of both rear corner posts.

11. A ROPS-capable cab frame for a vehicle, the cab frame comprising:
a left rear corner post and a right rear corner post, each corner post being curved to define a slanted transition portion between upper and lower portions thereof; and
a ROPS-capable beltline support member extending between the rear corner posts and spaced apart above the lower ends of the corner posts, the support member comprising a first part and a second part welded to the first part, the first part and the second part having flanged ends which are attached to the transition portions and which form gussets between the rear corner posts and the beltline support member.

12. The cab frame of claim 11, wherein:
the first part comprises a midportion having an upper side, a back plate and a lower side, one of said sides being wider than the other of said sides; and
the second part comprising a central portion, the central portion having a first edge which engages a surface the wider one of the sides of the first part, and the central portion having a side surface which engages an edge of the other side of the of the first part.

13. A beltline member for a vehicle cab frame, the cab frame having a left rear corner post and a right rear corner post, the rear corner posts extending upwardly from lower ends which are attached to a frame of the vehicle, the beltline member extending between the rear corner posts and spaced apart above the lower ends of the posts, characterized by:
the beltline member comprising a first part and a second part attached to the first part, the first part comprising a midportion, a left flange portion and a right flange portion, the midportion having a C-shaped cross sectional shape, and the second part comprising an elongated member having a first edge which engages an inner surface of the first part, and having a side surface which engages an edge of the first part.

14. The beltline member of claim 13, wherein:
the beltline member comprises a central portion, a left end fixed to the left rear corner post and a right end fixed to the right rear corner post, the central portion being offset rearwardly with respect to its left and right ends.

15. The beltline member of claim 13, wherein:
the first part comprises a midportion having an upper side, a back plate and a lower side, one of said sides being wider than the other of said sides; and
the second part comprising an elongated member having a first edge which engages a surface the wider one of the sides of the first part, and the elongated member having a side surface which engages an edge of the other side of the of the first part.

16. The beltline member of claim 13, wherein:
each end of the beltline member is fixed to a transition portion of the corresponding one of the rear corner posts, each of the transition portions being formed by a bend in the rear corner post between an upper portion and a lower portion thereof.
